(19) United States
(12) Patent Application Publication
(10) Pub. No.: US 2017/0220159 A1
(43) Pub. Date: Aug. 3, 2017

(54) MUTUAL CAPACITANCE TOUCH DISPLAY PANEL AND MANUFACTURING METHOD THEREOF

(71) Applicant: Shenzhen China Star Optoelectronics Technology Co., Ltd., Shenzhen City (CN)

(72) Inventor: Xiangyang Xu, Shenzhen City (CN)

(21) Appl. No.: 14/778,609

(22) PCT Filed: Jul. 23, 2015
(86) PCT No.: PCT/CN2015/084867

§ 371 Date: Sep. 21, 2015

(30) Foreign Application Priority Data
Jun. 29, 2015 (CN) 201510368573.4

(51) Int. Cl. G06F 3/041; G02F 1/1333; G02F 1/1339; G02F 1/1335; G02F 1/1343; G06F 3/044; G02F 1/1368

(52) U.S. Cl. CPC G06F 3/0412; G06F 3/044; G02F 1/13338; G02F 1/1368; G02F 1/133514; G02F 1/13439; G02F 1/134309; G02F 1/133512; G02F 1/13394; G02F 1/133516; G06F 2203/04103; G06F 2203/04104

(57) ABSTRACT

The present invention provides a mutual capacitance touch display panel and a manufacturing method thereof. The mutual capacitance touch display panel includes touch transmission electrodes (4) that are integrated on a surface of a CF substrate (2) that is distant from a liquid crystal layer (3) and transparent touch detection electrodes (5) integrated on a surface of the CF substrate (2) that is adjacent to the liquid crystal layer (3). The touch detection electrodes (5) are subjected to high temperature annealing treatment. The manufacturing method of the mutual capacitance touch display panel forms, before the formation of the liquid crystal layer (3), the transparent touch detection electrodes (5) on the surface of the CF substrate (2) that is adjacent to the liquid crystal layer (3) and applies high temperature annealing to reduce the impedance of the touch detection electrodes (5), laminates the CF substrate (2) to a TFT base plate (1), and forms, after the formation of the liquid crystal layer (3), the touch transmission electrodes (4) on the surface of the CF substrate (2) that distant from the liquid crystal layer (3). The present invention reduces the impedance of the touch detection electrodes and increases the touch sensitivity of the touch display panel.

### BACKGROUND OF THE INVENTION

1. Field of the Invention

The present invention relates to the field of display technology, and in particular to a mutual capacitance touch display panel and a manufacturing method thereof.

2. The Related Arts

With the rapid process of the display technology, touch display panels have been widely accepted and used by people. For example, intelligent phones and tablet computers both involve the use of touch display pane. The touch display panel is formed by applying the embedding touch technology to combine a touch panel and a liquid crystal display panel with each other as a unit with the functionality of the touch panel embedded in the liquid crystal display panel to make the liquid crystal display panel to simultaneously possess the functions of displaying and touch control/input.

The liquid crystal display panels are generally made up of a color filter (CF) substrate, a thin-film transistor (TFT) array substrate, and a liquid crystal layer interposed between the two substrates, of which the principle of operation is to control liquid crystal molecule to rotate by applying a driving voltage to the two glass substrates in order to refract out light from a backlight module to generate an image. According to the different ways of alignment of the liquid crystal, the liquid crystal display panels of the main stream market can be classified in several types: vertical alignment (VA), twisted nematic (TN) or super twisted nematic (STN), in-plane switching (IPS), and fringe field switching (FFS).

The touch display panels can be classified, according to techniques of detection applied, four types, which are resistive type, capacitive type, optical type, and acoustic wave type. The main stream of the touch technology is the capacitive type, which is further divided into self-capacitance type and mutual capacitance type. The capacitive touch display panels that are currently available in the market are primarily the mutual capacitance type. An advantage of the mutual capacitance type is the capability of multiple point touch control. The touch display panels can be further classified, according to the structures thereof, into on-cell type, in-cell type, and external mounting type, among which the in-cell type possess advantages of low cost, being ultra-thin, and narrowed frame and are generally applied in high-end touch products. However, due to factors, such as higher technical difficulty and being susceptible to signal interference, the sensitivity of the in-cell touch control is generally poor. The touch display panels that are most widely used in the current market are the external mounting type. Advantages of the external mounting type include high sensitivity and fast response speed, but there are also disadvantages including high cost and limitation on product thinning. The on-cell types possesses the advantages of both the external mounting type and the in-cell type and thus has increased sensitivity and allows for reduction of panel thickness. However, a manufacturing process of an on-cell touch display panel allows a transparent electrode of indium tin oxide (ITO) that is provided for making a touch control circuit to be coated on a panel surface after boxing of liquid crystal. ITO has a limited annealing temperature so that the impedance can hardly be lowered, leading to a constrain to the increase of touch sensitivity.

### SUMMARY OF THE INVENTION

An object of the present invention is to provide a mutual capacitance touch display panel, which comprises a touch detection electrode having a reduced impedance so as to provide increased touch sensitivity.

Another object of the present invention is to provide a manufacturing method of a mutual capacitance touch display panel, which, without increasing operations of a manufacturing process and affecting aperture rate of a panel, reduces the impedance of a touch detection electrode and increases the touch sensitivity of the touch display panel.

To achieve the above objects, the present invention provides a mutual capacitance touch display panel, comprising: a thin-film transistor (TFT) array substrate, a color filter (CF) substrate opposite to the TFT array substrate, a liquid crystal layer interposed between the TFT array substrate and the CF substrate, a plurality of touch transmission electrodes formed on a surface of the CF substrate that is distant from the liquid crystal layer and parallel to each other, and a plurality of transparent touch detection electrodes formed on a surface of the CF substrate that is adjacent to the liquid crystal layer and are parallel to each other and are perpendicular to the touch transmission electrodes in space;

the touch detection electrodes being subjected to high temperature annealing treatment.

The CF substrate comprises a base plate. The plurality of touch transmission electrodes is arranged on a surface of the base plate that is distant from the liquid crystal layer. The plurality of touch detection electrodes is arranged on a surface of the base plate that is adjacent to the liquid crystal layer. The CF substrate further comprises a plurality of color resists arranged on the base plate and the touch detection electrodes, a plurality of black matrixes separating the color resists, a plurality of photo spacer arranged on the black matrixes, and an alignment film covering the color resists, the black matrixes, and the photo spacers.

The touch detection electrodes are formed of a material of indium tin oxide (ITO).

The touch detection electrodes have a thickness of 500-1000 Å.

The touch transmission electrodes are formed of a material of ITO or a metal.

The present invention also provides a mutual capacitance touch display panel, which comprises: a TFT array substrate, a CF substrate opposite to the TFT array substrate, a liquid crystal layer interposed between the TFT array substrate and the CF substrate, a plurality of touch transmission electrodes formed on a surface of the CF substrate that is distant from the liquid crystal layer and parallel to each other, and a plurality of transparent touch detection electrodes formed on a surface of the CF substrate that is adjacent to the liquid crystal layer and are parallel to each other and are perpendicular to the touch transmission electrodes in space;

the touch detection electrodes being subjected to high temperature annealing treatment;

wherein the CF substrate comprises a base plate, the plurality of touch transmission electrodes being arranged on a surface of the base plate that is distant from the liquid crystal layer, the plurality of touch detection electrodes being arranged on a surface of the base plate that is adjacent to the liquid crystal layer, the CF substrate further comprising a plurality of color resists arranged on the base plate and the touch detection electrodes, a plurality of black matrixes separating the color resists, a plurality of photo spacers arranged on the black matrixes, and an alignment film covering the color resists, the black matrixes, and the photo spacers;

wherein the touch detection electrodes are formed of a material of ITO; and

wherein the touch transmission electrodes are formed of a material of ITO or a metal.

The present invention further provides a manufacturing method of a mutual capacitance touch display panel, which comprises the following steps:

(1) providing a base plate, coating a transparent conductive film on a surface of the base plate, and patterning the transparent conductive film through a masking and etching operation so as to form a plurality of parallel and transparent touch detection electrodes;

(2) subjecting the plurality of parallel and transparent touch detection electrodes to high temperature annealing so as to reduce impedance of the touch detection electrodes;

(3) applying masking and etching operations to form, in sequence, a plurality of black matrixes, a plurality of color resists, and a plurality of photo spacers on the base plate and the touch detection electrodes,

wherein the black matrix separates the color resist and the photo spacer is formed on the black matrix;

(4) coating an alignment liquid on the color resist, the black matrix, and the photo spacer to form an alignment film thereby forming a CF substrate;

(5) providing a TFT array substrate and laminating the TFT array substrate and the CF substrate together with the touch detection electrodes facing the TFT array substrate; filling liquid crystal between the TFT array substrate and the CF substrate to form a liquid crystal layer; and

(6) coating a conductive film on a surface of the base plate of the CF substrate that is distant from the liquid crystal layer; patterning the conductive film through a masking and etching operation to form a plurality of touch transmission electrodes that is parallel to each other and is perpendicular to the touch detection electrodes in space.

In step (1), the transparent conductive film is formed of a material of ITO.

The transparent conductive film has a thickness of 500-1000 Å.

In step (6), the conductive film is formed of a material of ITO or a metal.

The base plate comprises a glass plate.

The efficacy of the present invention is that the present invention provides a mutual capacitance touch display panel that comprises touch transmission electrodes integrated with a surface of the CF substrate that is distant from a liquid crystal layer and transparent touch detection electrodes integrated with a surface of the CF substrate that is adjacent to the liquid crystal layer. In addition, the touch detection electrodes are subjected to high temperature annealing treatment so that the touch detection electrodes have a reduced impedance to provide the touch display panel with increased sensitivity. The present invention also provides a manufacturing method of a mutual capacitance touch display panel, which forms, before the formation of a liquid crystal layer, transparent touch detection electrodes on a surface of a CF substrate that is adjacent to the liquid crystal layer to be formed and applies high temperature annealing to reduce the electrical impedance of the touch detection electrodes and then, laminates the CF substrate to a TFT base plate and forms, after the formation of the liquid crystal layer, touch transmission electrodes on a surface of the CF substrate that is distant from the liquid crystal layer so as to achieve reduction of the electrical impedance of the touch detection electrodes without involving additional manufacturing operations and affecting the aperture ratio of the panel thereby increasing the touch sensitivity of the touch display panel.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing a structure of a mutual capacitance touch display panel according to the present invention;

FIG. 2 is a top plan view of a touch detection electrode and a touch transmission electrode of the mutual capacitance touch display panel according to the present invention; and

FIG. 3 is a flow chart illustrating a manufacturing method of a mutual capacitance touch display panel according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

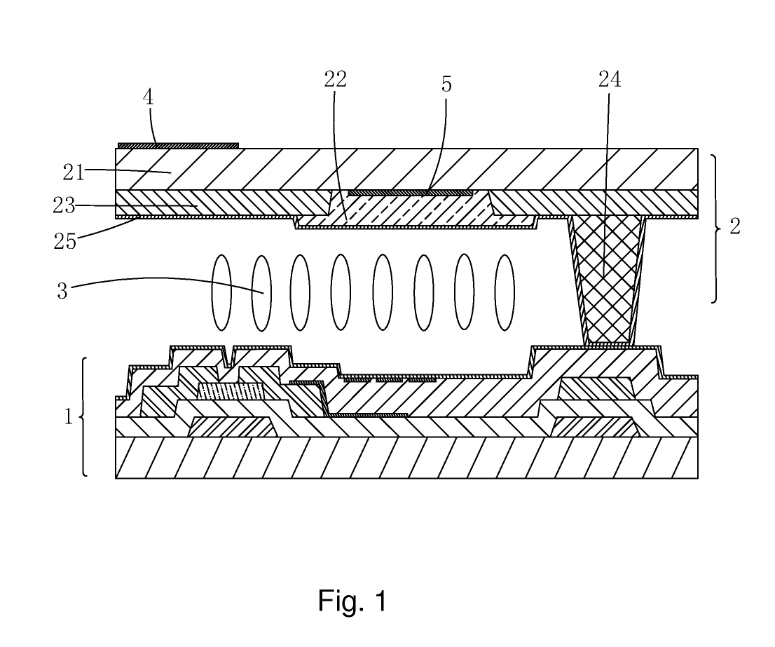

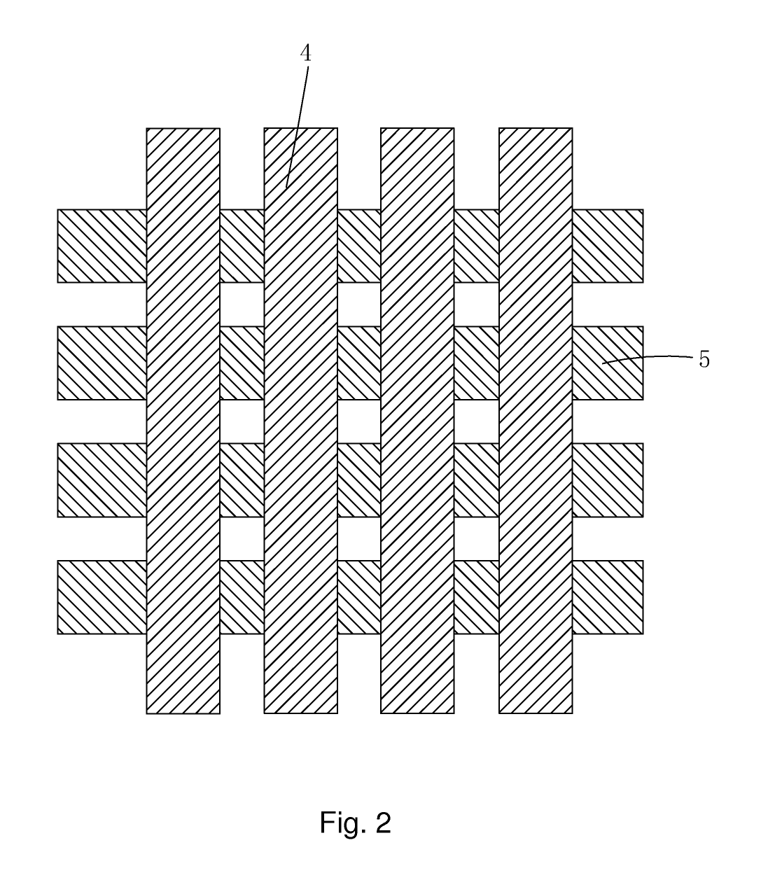

Referring to both FIGS. 1 and 2, firstly, the present invention provides a mutual capacitance touch display panel, which comprises: a thin-film transistor (TFT) array substrate 1, a color filter (CF) substrate 2 opposite to the TFT array substrate 1, a liquid crystal layer 3 interposed between the TFT array substrate 1 and the CF substrate 2, a plurality of touch transmission electrodes 4 formed on a surface of the CF substrate 2 that is distant from the liquid crystal layer 3 and parallel to each other, and a plurality of transparent touch detection electrodes 5 formed on a surface of the CF substrate 2 that is adjacent to the liquid crystal layer 3 and are parallel to each other and are perpendicular to the touch transmission electrodes 4 in space.

The TFT array substrate 1 comprises a substrate base plate, a gate terminal, a gate insulation layer, a semiconductor layer, source/drain terminals, a pixel electrode, a protection layer, a comb-like common electrode, and an alignment film and is similar to a TFT array substrate that is involved in a known IPS or FFS liquid crystal display panel so that no detail will be provided herein.

The CF substrate 2 comprises a base plate 21. The plurality of touch transmission electrodes 4 is arranged on a surface of the base plate 1 that is distant from the liquid crystal layer 3. The touch detection electrodes 5 are arranged on a surface of the base plate 1 that is adjacent to the liquid crystal layer 3. The CF substrate 2 further comprises a plurality of color resists 22 arranged on the base plate 21 and the plurality of touch detection electrodes 5, a plurality of black matrixes 23 separating the color resists 22, a plurality of photo spacers 24 arranged on the black matrixes 23, and an alignment film 25 covering the color resists 22, the black matrixes 23, and the photo spacers 24.

The touch detection electrodes 5 are subjected to high temperature annealing treatment.

Specifically, the base plate 21 is a glass plate.

The touch detection electrodes 5 are formed of a material of indium tin oxide (ITO) having a thickness of 500-1000 Å.

The touch transmission electrodes 4 are formed of a material of ITO or are alternatively formed of a metal.

The present invention provides a mutual capacitance touch display panel that comprises touch transmission electrodes 4 integrated with a surface of the CF substrate 2 that is distant from a liquid crystal layer 3 and transparent touch detection electrodes 5 integrated with a surface of the CF substrate 2 that is adjacent to the liquid crystal layer 3. In addition, the touch detection electrodes 5 are subjected to high temperature annealing treatment so that the touch detection electrodes 5 have a reduced impedance to provide the touch display panel with increased sensitivity.

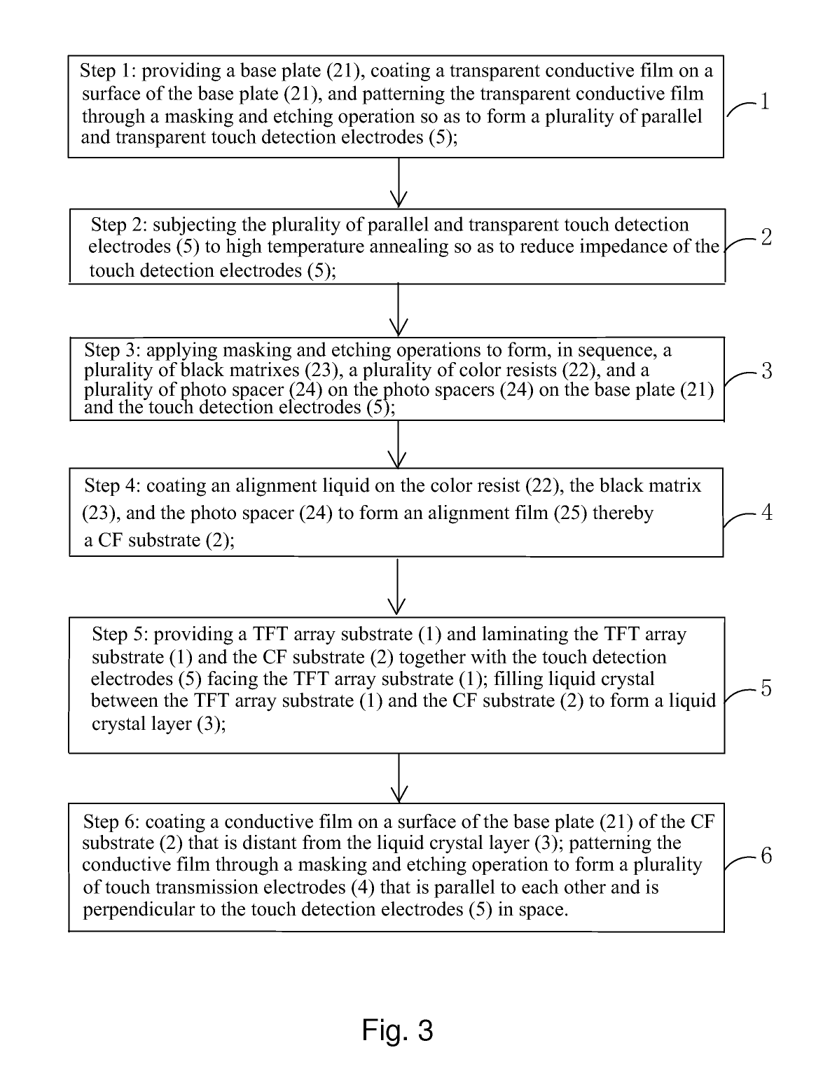

Referring to FIG. 3, in combination with FIGS. 1 and 2, the present invention further provides a manufacturing method of a mutual capacitance touch display panel, which comprises the following steps:

Step 1: providing a base plate 21, coating a transparent conductive film on a surface of the base plate 21, and patterning the transparent conductive film through a masking and etching operation so as to form a plurality of parallel and transparent touch detection electrodes 5.

Specifically, the base plate 21 is preferably a glass plate and the transparent conductive film is formed of a material of ITO having a thickness of 500-1000 Å.

Step 2: subjecting the plurality of parallel and transparent touch detection electrodes 5 to high temperature annealing so as to reduce impedance of the touch detection electrodes 5.

Step 3: applying masking and etching operations to form, in sequence, a plurality of black matrixes 23, a plurality of color resists 22, and a plurality of photo spacers 24 on the base plate 21 and the touch detection electrodes 5,

wherein the black matrixes 23 separate the color resists 22 and the photo spacers 24 are formed on the black matrixes 23.

Step 4: coating an alignment liquid on the color resists 22, the black matrixes 23, and the photo spacers 24 to form an alignment film 25 thereby forming a CF substrate 2.

Step 5: providing a TFT array substrate 1 and laminating the TFT array substrate 1 and the CF substrate 2 together with the touch detection electrodes 5 facing the TFT array substrate 1; filling liquid crystal between the TFT array substrate 1 and the CF substrate 2 to form a liquid crystal layer 3.

A structure of the TFT array substrate 1 and a method applicable to the manufacture thereof are similar to those of a TFT array substrate involved in a known IPS or FFS liquid crystal display panel so that no detail will be provided herein.

Step 6: coating a conductive film on a surface of the base plate 21 of the CF substrate 2 that is distant from the liquid crystal layer 3; patterning the conductive film through a masking and etching operation to form a plurality of touch transmission electrodes 4 that is parallel to each other and is perpendicular to the touch detection electrodes 5 in space.

Specifically, the conductive film is formed of a material of ITO or a metal.

The present invention provide a manufacturing method of a mutual capacitance touch display panel, which forms, before the formation of a liquid crystal layer 3, transparent touch detection electrodes 5 on a surface of a CF substrate 2 that is adjacent to the liquid crystal layer 3 to be formed and applies high temperature annealing to reduce the electrical impedance of the touch detection electrodes 5 and then, laminates the CF substrate 2 to a TFT base plate 1 and forms, after the formation of the liquid crystal layer 3, touch transmission electrodes 4 on a surface of the CF substrate 2 that is distant from the liquid crystal layer 3 so as to achieve reduction of the electrical impedance of the touch detection electrodes 5 without involving additional manufacturing operations and affecting the aperture ratio of the panel thereby increasing the touch sensitivity of the touch display panel.

In summary, the present invention provides a mutual capacitance touch display panel that comprises touch transmission electrodes integrated with a surface of the CF substrate that is distant from a liquid crystal layer and transparent touch detection electrodes integrated with a surface of the CF substrate that is adjacent to the liquid crystal layer. In addition, the touch detection electrodes are subjected to high temperature annealing treatment so that the touch detection electrodes have a reduced impedance to provide the touch display panel with increased sensitivity. The present invention also provides a manufacturing method of a mutual capacitance touch display panel, which forms, before the formation of a liquid crystal layer, transparent touch detection electrodes on a surface of a CF substrate that is adjacent to the liquid crystal layer to be formed and applies high temperature annealing to reduce the electrical impedance of the touch detection electrodes and then, laminates the CF substrate to a TFT base plate and forms, after the formation of the liquid crystal layer, touch transmission electrodes on a surface of the CF substrate that is distant from the liquid crystal layer so as to achieve reduction of the electrical impedance of the touch detection electrodes without involving additional manufacturing operations and affecting the aperture ratio of the panel thereby increasing the touch sensitivity of the touch display panel.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A mutual capacitance touch display panel, comprising: a thin-film transistor (TFT) array substrate, a color filter (CF) substrate opposite to the TFT array substrate, a liquid crystal layer interposed between the TFT array substrate and the CF substrate, a plurality of touch transmission electrodes formed on a surface of the CF substrate that is distant from the liquid crystal layer and parallel to each other, and a plurality of transparent touch detection electrodes formed on a surface of the CF substrate that is adjacent to the liquid crystal layer and are parallel to each other and are perpendicular to the touch transmission electrodes in space;
the touch detection electrodes being subjected to high temperature annealing treatment.

2. The mutual capacitance touch display panel as claimed in claim 1, wherein the CF substrate comprises a base plate, the plurality of touch transmission electrodes being arranged on a surface of the base plate that is distant from the liquid crystal layer, the plurality of touch detection electrodes being arranged on a surface of the base plate that is adjacent to the liquid crystal layer; the CF substrate further comprising a plurality of color resists arranged on the base plate and the touch detection electrodes, a plurality of black matrixes separating the color resists, a plurality of photo spacers arranged on the black matrixes, and an alignment film covering the color resists, the black matrixes, and the photo spacers.

3. The mutual capacitance touch display panel as claimed in claim 1, wherein the touch detection electrodes are formed of a material of indium tin oxide (ITO).

4. The mutual capacitance touch display panel as claimed in claim 3, wherein the touch detection electrodes have a thickness of 500-1000 Å.

5. The mutual capacitance touch display panel as claimed in claim 1, wherein the touch transmission electrodes are formed of a material of ITO or a metal.

6. A mutual capacitance touch display panel, comprising: a thin-film transistor (TFT) array substrate, a color filter (CF) substrate opposite to the TFT array substrate, a liquid crystal layer interposed between the TFT array substrate and the CF substrate, a plurality of touch transmission electrodes formed on a surface of the CF substrate that is distant from the liquid crystal layer and parallel to each other, and a plurality of transparent touch detection electrodes formed on a surface of the CF substrate that is adjacent to the liquid crystal layer and are parallel to each other and are perpendicular to the touch transmission electrodes in space;
the touch detection electrodes being subjected to high temperature annealing treatment;
wherein the CF substrate comprises a base plate, the plurality of touch transmission electrodes being arranged on a surface of the base plate that is distant from the liquid crystal layer, the plurality of touch detection electrodes being arranged on a surface of the base plate that is adjacent to the liquid crystal layer; the CF substrate further comprising a plurality of color resists arranged on the base plate and the touch detection electrodes, a plurality of black matrixes separating the color resists, a plurality of photo spacers arranged on the black matrixes, and an alignment film covering the color resists, the black matrixes, and the photo spacers;
wherein the touch detection electrodes are formed of a material of indium tin oxide (ITO); and
wherein the touch transmission electrodes are formed of a material of ITO or a metal.

7. The mutual capacitance touch display panel as claimed in claim 6, wherein the touch detection electrodes have a thickness of 500-1000 Å.

8. A manufacturing method of a mutual capacitance touch display panel, comprising the following steps:
(1) providing a base plate, coating a transparent conductive film on a surface of the base plate, and patterning the transparent conductive film through a masking and etching operation so as to form a plurality of parallel and transparent touch detection electrodes;
(2) subjecting the plurality of parallel and transparent touch detection electrodes to high temperature annealing so as to reduce impedance of the touch detection electrodes;
(3) applying masking and etching operations to form, in sequence, a plurality of black matrixes, a plurality of color resists, and a plurality of photo spacers on the base plate and the touch detection electrodes,
wherein the black matrixes separate the color resists and the photo spacers are formed on the black matrixes;
(4) coating an alignment liquid on the color resists, the black matrixes, and the photo spacers to form an alignment film thereby forming a color filter (CF) substrate;
(5) providing a thin-film transistor (TFT) array substrate and laminating the TFT array substrate and the CF substrate together with the touch detection electrodes facing the TFT array substrate; filling liquid crystal between the TFT array substrate and the CF substrate to form a liquid crystal layer; and
(6) coating a conductive film on a surface of the base plate of the CF substrate that is distant from the liquid crystal layer; patterning the conductive film through a masking and etching operation to form a plurality of touch transmission electrodes that is parallel to each other and is perpendicular to the touch detection electrodes in space.

9. The manufacturing method of the mutual capacitance touch display panel as claimed in claim 8, wherein in step (1), the transparent conductive film is formed of a material of indium tin oxide (ITO).

10. The manufacturing method of the mutual capacitance touch display panel as claimed in claim 9, wherein the transparent conductive film has a thickness of 500-1000 Å.

11. The manufacturing method of the mutual capacitance touch display panel as claimed in claim 8, wherein in step (6), the conductive film is formed of a material of ITO or a metal.

12. The manufacturing method of the mutual capacitance touch display panel as claimed in claim 8, wherein the base plate comprises a glass plate.
